(19) United States
(12) Patent Application Publication
(10) Pub. No.: US 2023/0099435 A1
(43) Pub. Date: Mar. 30, 2023

(54) METHOD AND APPARATUS FOR NETWORK SLICE ADMISSION CONTROL FOR INTERWORKING WITH EPC IN WIRELESS NETWORK

(71) Applicant: Samsung Electronics Co., Ltd., Suwon-si (KR)

(72) Inventors: Koustav ROY, Bangalore (IN); Arijit SEN, Bangalore (IN); Danish Ehsan HASHMI, Bangalore (IN); Lalith KUMAR, Bangalore (IN)

(21) Appl. No.: 17/956,147

(22) Filed: Sep. 29, 2022

(30) Foreign Application Priority Data
Sep. 30, 2021 (IN) 202141044491
Sep. 30, 2021 (IN) 202141044491
Sep. 8, 2022 (IN) 2021 41044301

(51) Int. Cl. H04W 48/06

(52) U.S. Cl. CPC H04W 48/06

(57) ABSTRACT

The disclosure relates to a fifth generation (5G) or sixth generation (6G) communication system. A method for Network slice admission control for interworking with an Evolved Packet Core Network (EPC) in a wireless network by a Session Management Function-Packet Data Network Gateway (SMF-PGW-C) is provided. The method includes detecting that at least one UE transfers a Packet Data Network (PDN) connection or a Protocol Data Unit (PDU) session from a N1 mode to a S1 mode during an intersystem change. Further, the method includes determining that an EPC counting is not required for a network slice of the wireless network. Further, the method includes transmitting a message to a Network Slice Admission Control Function (NSACF) in the wireless network to update or reduce a number of User Equipments (UEs) per network slice and a number of PDU sessions per network slice.

### CROSS-REFERENCE TO RELATED APPLICATION(S)

This application is based on and claims priority under 35 U.S.C. § 119(a) of an Indian Provisional patent application number 202141044301, filed on Sep. 29, 2021, in the Indian Intellectual Property Office, and of an Indian Provisional patent application number 202141044491, filed on Sep. 30, 2021, in the Indian Intellectual Property Office, and of an Indian Complete patent application number 202141044301, filed on Sep. 8, 2022, in the Indian Intellectual Property Office, the disclosure of each of which is incorporated by reference herein in its entirety.

### BACKGROUND

### 1. Field

The disclosure relates to a field of wireless networks. More particularly, the disclosure relates to a system and a method to maintain Network Slice Admission Control Function (NSACF) count for interworking with an Evolved Packet Core (EPC) in the wireless network.

### 2. Description of Related Art

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, New Radio (NR) User Equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

This disclosure relates to scheduling for a UE capable of receptions over multiple antenna panels.

Aspects of the disclosure are to address at least the above-mentioned problems and/or disadvantages and to provide at least the advantages described below. Accordingly, an aspect of the disclosure is to provide efficient communication methods in a wireless communication system.

Another aspect of the disclosure is to provide to methods and apparatuses for network slice admission control.

Another aspect of the disclosure is to maintain a NSAC Fcount for interworking with an EPC in a wireless network. In an embodiment, if an EPS counting is not required for a network slice, the network performs network slice admission control for the S-NSSAI(s) subject to NSAC to decrease the number of UEs per network slice and number of PDU sessions per network slice due to transfer of the PDN connection from N1 mode to S1 mode in case of inter-system change.

Another aspect of the disclosure is to maintain NSACF count in an EPS only mode UEs.

Additional aspects will be set forth in part in the description which follows and, in part, will be apparent from the description, or may be learned by practice of the presented embodiments.

In accordance with an aspect of the disclosure, a method for Network slice admission control for interworking with an Evolved Packet Core (EPC) in a wireless network is provided. The method includes detecting, by a Session Management Function-Packet Data Network Gateway (SMF-PGW-C) in the wireless network, that at least one UE transfer a Packet Data Network (PDN) connection or a Protocol Data Unit (PDU) session from a N1 mode to a S1 mode during an intersystem change. Further, the method includes determining, by the SMF-PGW-C, that an EPC counting is not required for a network slice of the wireless network. Further, the method includes transmitting, by the SMF-PGW-C, a message to a Network Slice Admission Control Function (NSACF) in the wireless network to update or reduce a number of UEs per network slice and a number of PDU sessions per network slice due to transfer of the PDN connection or the PDU session from the N1 mode to the S1 mode.

In accordance with another aspect of the disclosure, a method for Network slice admission control for interworking with an EPC in a wireless network is provided. The method includes detecting, a NSACF in the wireless network, that an EPC counting is not required for a network slice of the wireless network. Further, the method includes receiving, by the NSACF, a message from a SMF-PGW-C in the wireless network to update or reduce a number of UEs per network slice and a number of PDU sessions per network slice when at least one UE in the wireless network transfer a PDN connection or a PDU session from a N1 mode to a S1 mode during an intersystem change. Further, the method includes updating or reducing, by the NSACF, the number of UEs per network slice and the number of PDU sessions per network slice based on the message received from the SMF-PGW-C.

In accordance with another aspect of the disclosure, a SMF-PGW-C for Network slice admission control for interworking with an EPC in a wireless network is provided. The SMF-PGW-C includes a network slice admission controller communicatively coupled to a memory and a processor. The network slice admission controller detects that at least one UE transfer a PDN connection or a PDU session from a N1 mode to a S1 mode during an intersystem change. Further, the network slice admission controller determines that an EPC counting is not required for a network slice of the wireless network. Further, the network slice admission controller transmits a message to a NSACF in the wireless network to update or reduce a number of UEs per network slice and a number of PDU sessions per network slice due to transfer of the PDN connection or the PDU session from the N1 mode to the S1 mode.

In accordance with another aspect of the disclosure, a NSACF for Network slice admission control for interworking with an EPC in a wireless network is provided. The NSACF includes a network slice admission controller communicatively coupled to a memory and a processor. The network slice admission controller detects that an EPC counting is not required for a network slice of the wireless network. Further, the network slice admission controller receives a message from a SMF-PGW-C in the wireless network to update or reduce a number of UEs per network slice and a number of PDU sessions per network slice when at least one UE in the wireless network transfer a PDN connection or a PDU session from a N1 mode to a S1 mode during an intersystem change. Further, the network slice admission controller updates or reduces the number of UEs per network slice and the number of PDU sessions per network slice based on the message received from the SMF-PGW-C.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrating a scenario of applicability of NSAC for a UE not supporting N1 mode, according to the related art;

FIG. 2 illustrating a scenario of inter system change from a 5GC to an EPC, according to the related art;

FIG. 3 illustrating a scenario of NSACF check should be done in an EPS, according to an embodiment of the disclosure;

FIG. 4 illustrating a scenario of NSACF check should not be done in the EPS for N1 mode disabled UE, according to an embodiment of the disclosure;

FIG. 5 illustrating a scenario of an inter system change from a 5GC to an EPC, according to an embodiment of the disclosure;

FIG. 6 shows various hardware components of a SMF-PGW-C, according to an embodiment of the disclosure;

FIG. 7 shows various hardware components of a NSACF, according to an embodiment of the disclosure;

FIG. 8 is a flow chart illustrating a method, implemented by the SMF-PGW-C, for network slice admission control for interworking with an EPC in a wireless network, according to an embodiment of the disclosure;

FIG. 9 is a flow chart illustrating a method, implemented by the NSACF, for network slice admission control for interworking with the EPC in the wireless network, according to an embodiment of the disclosure;

FIG. 10 is a block diagram illustrating an internal structure of a network entity, according to an embodiment of the disclosure;

FIG. 11 is a block diagram of a structure of a UE according to an embodiment of the disclosure; and

FIG. 12 is a block diagram of a structure of a BS according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, denotes to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” denotes any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, denotes that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Below are the abbreviations used in the description:

NSAC—Network Slice Admission Control

NSACF—Network Slice Admission Control Function

AMF—Access and Mobility Management Function

NEF—Network Exposure Function

NF—Network Function

NSSAI—Network Slice Selection Assistance Information

NSSF—Network Slice Selection Function

S-NSSAI—Single Network Slice Selection Assistance Information

SMF—Session Management Function

UPF—User Plane Function

EPS—Evolved Packet System

EPC: Evolved Packet Core Network

MME: Mobility Management Entity

PGW-C: Packet Data Network Gateway

UE—User Equipment

PDU—Protocol Data Unit

PDN—Packet Data Network

In general, the Network Slice Admission Control Function (NSACF) (aka “NSACF device”) monitors and controls a number of registered User Equipment's (UEs) per network slice and a number of protocol data unit (PDU) sessions per network slice for the network slices that are subject to Network Slice Admission Control (NSAC). The NSACF is also configured with information indicating which access type is specified for a Single Network Slice Selection Assistance Information (S-NSSAI) subject to the NSAC. The access type can be a 3rd Generation Partnership Project (3GPP) access type, a Non-3GPP access type, or both. Further, the NSACF controls (i.e. increase or decrease) a current number of a protocol data unit (PDU) and/or NSACF function for maximum number of the UEs sessions per network slice so that it does not exceed the maximum number of the PDU session and/or registered UEs allowed to be served by that network slice. When the current number of the PDU sessions with the network slice is to be increased, the NSACF first checks whether the maximum number of PDU sessions per network slice for that network slice has already been reached. When the current number of registered UE with network slice is to be increased, the NSACF first checks whether the maximum number of registered UE per network slice for that network slice has already been reached.

An anchor Session Management Function (SMF) triggers a request to the NSACF for maximum number of PDU sessions per network slice control during the PDU session establishment/release procedures. Further, the SMF provides the access type to the NSACF when triggering the request to increase or decrease the number of the PDU Sessions. The NSAC takes the access type into account for increasing and decreasing the current number of PDU Sessions depending on the applicability of the access type for the NSAC for maximum number of PDU Sessions for the S-NSSAI.

In general, if an Evolved Packet System (EPS) counting is required for a network slice, a Network Slice Admission Control (NSAC) for maximum number of the UEs and/or for maximum number of protocol data unit (PDU) Sessions per network slice is performed at the time of packet data network (PDN) connection establishment in case of evolved packet core (EPC) interworking.

In order to support the NSAC for maximum number of UEs and/or for maximum number of the PDU Sessions per network slice in the EPC, the SMF+PGW-C is configured with the information indicating which network slice is subject to the NSAC. During PDN connection establishment in the EPC, the SMF+PGW-C selects a Single Network Slice Selection Assistance Information (S-NSSAI) associated with the PDN connection. If the selected S-NSSAI by the SMF+PGW-C is subject to the NSAC, the SMF+PGW-C triggers interaction with NSACF to check the availability of the network slice, before the SMF+PGW-C provides the selected S-NSSAI to the UE. If the network slice is available, the SMF+PGW-C continue to proceed with the PDN connection establishment procedure.

In other words, as per the methods and systems of the related art, if EPS counting is required for the network slice, the Network Slice Admission Control for maximum number of UEs and/or for maximum number of PDU Sessions per network slice is performed at the time of PDN connection establishment. If the UE does not support N1 mode or disables N1 mode temporarily, applicability to support the NSAC for maximum number of UEs and/or for maximum number of PDU Sessions per network slice in EPC is not clear. Also as per the methods and systems of the related art, the SMF+PGW-C does not differentiate PDN connection request based on a N1 mode support in the UE as the information of N1 mode support is not available in SMF+PGW-C.

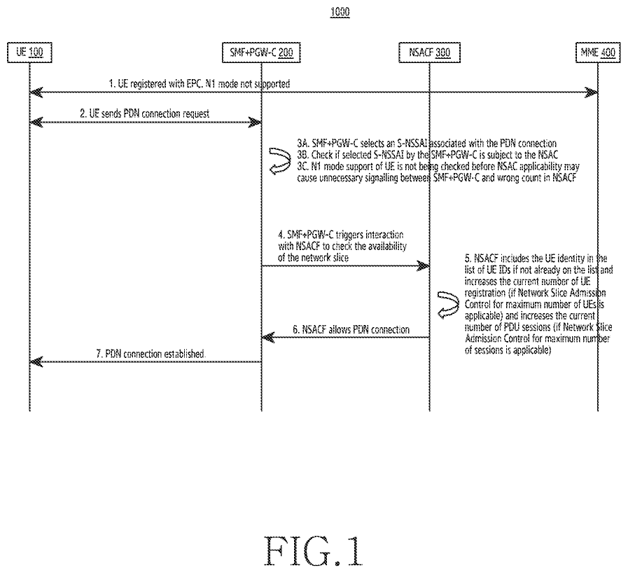

FIG. 1 illustrating a scenario of applicability of NSAC for UE (100) not supporting N1 mode, according to the related art.

Referring to FIG. 1, the steps are as follows: At operation 1, initially the UE (100) is registered with EPC. N1 mode not supported between the UE (100) and an Mobility Management Entity (MME) (400). At operation 2, the UE (100) sends a PDN connection request to the SMF+PGW-C.

At operation 3A, the SMF+PGW-C (200) selects an S-NSSAI associated with the PDN connection. At operation 3B, the SMF+PGW-C (200) check if selected S-NSSAI by the SMF+PGW-C (200) is subject to the NSAC. At operation 3C, the N1 mode support of the UE (100) is not being checked before NSAC applicability may cause unnecessary signaling between SMF+PGW-C (200) and wrong count in NSACF (300).

At operation 4, the SMF+PGW-C (200) triggers interaction with NSACF (300) to check the availability of the network slice. At operation 5, the NSACF (300) includes the UE identity in the list of UE IDs if not already on the list and increases the current number of UE registration (if Network Slice Admission Control for maximum number of UEs is applicable) and increases the current number of PDU sessions (if Network Slice Admission Control for maximum number of sessions is applicable).

At operation 6, the NSACF (300) allows PDN connection with the SMF+PGW-C (200). At operation 7, at the end the PDN connection is established.

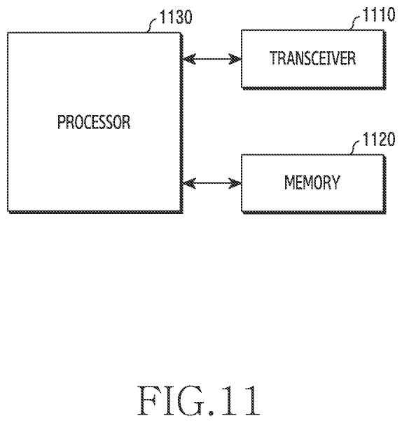

Now if a new UE attempts to registered directly on the 5GS network it may not be allowed to be registered with the network if maximum number of UEs per network slice threshold is reached, or if a new PDU session is attempted to be established it may not be allowed to be established as maximum number of PDU Sessions per network slice count is reached. Thus the UE (100) which does not even support N1 mode is counted while allowing its registration in EPS network can impact the UEs which may attempt to register/or establish a PDU session on 5GS network. The UE (100) which does not even support N1 mode will never go to 5GS network but 5GS feature of network slice admission control is applied on such UEs, it is desired to address the above mentioned disadvantages or other shortcomings or at least provide a useful alternative. the UE (100) may include more or fewer components than those described above. In addition, the UE (100) corresponds to the UE of FIG. 11.

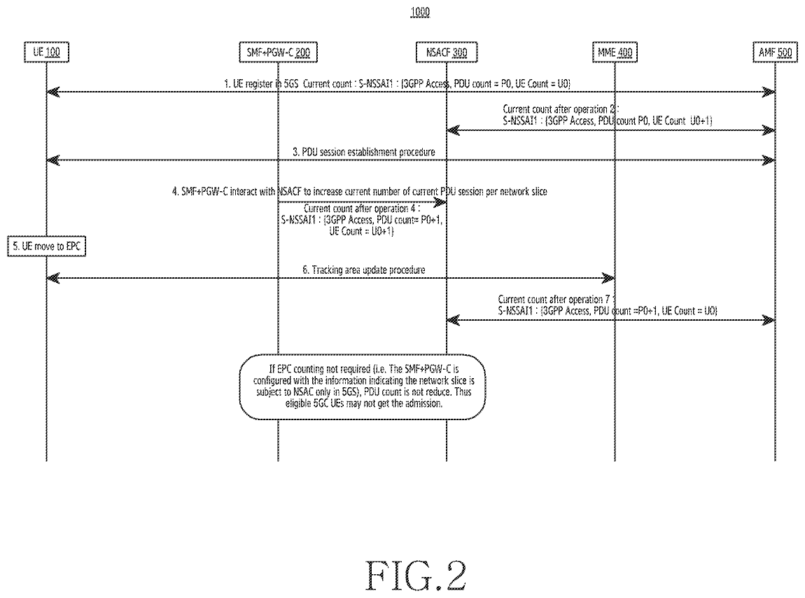

FIG. 2 illustrating a scenario of inter system change from a 5GC to an EPC, according to the related art.

Referring to FIG. 2, at operation 1, the S-NSSAI1 is subject to the NSAC and the UE (100) registers in the 5GS. At operation 2, the NSACF (300) have the count for current number of PDU sessions and current number of UE(s) for S-NSSAI1 (S-NSSAI1: {3GPP Access, PDU count=P0+1, UE Count=U0}).

As per methods and systems of the related art, in operation 2, the AMF (500) interacts with the NSACF (300) to increase the current number of UE count per slice (S-NSSAI1). After operation 2, the NSACF (300) have the count for current number of PDU sessions and current number of UE(s) for S-NSSAI1 as S-NSSAI1: {3GPP Access, PDU count=P0, UE Count=U0+1}. At operation 3, PDU session establishment procedure is initiated between the UE (100) and the AMF (500)!SMF+PGW-C (200).

In operation 4, SMF+PGW-C (200) interacts with NSACF to increase the current number of PDU session count per slice for SNSSAI1. After operation 4, the NSACF (300) have the count for current number of PDU sessions and current number of UE(s) for S-NSSAI1 as S-NSSAI1: {3GPP Access, PDU count=P0+1, UE Count=U0+1}.

In operation 5, UE (100) move to EPC (LTE), the UE (100) will initiate tracking area update request (operation 6). This makes the interaction with the AMF (500). In operation 7, the AMF (500) interacts with NSACF (300) to decrease the current number of UE count per slice for S-NSSAI1. After operation 7, NSACF (300) have the count for current number of PDU sessions and current number of UE(s) for S-NSSAI1 as S-NSSAI1: {3GPP Access, PDU count=P0+1, UE Count=U0}. If EPC counting not required (i.e. The SMF+PGW-C (200) is configured with the information indicating the network slice is subject to NSAC only in 5GS).

As there is no interaction defined with NSACF (300) with the EPC or SMF+PGW-C (200), the NSACF (300) will maintain current number of PDU session count (P0+1) for the S-NSSAI despite UE (100) moved to the EPC where the NSAC for PDU session is not configured. Because of this wrong counting, the eligible 5GC UEs may not get the admission for PDU sessions if maximum allowed PDU session (threshold) is reached on S-NSSAI (S-NSSAI1).

Thus, it is desired to address the above mentioned disadvantages or other shortcomings or at least provide a useful alternative.

Accordingly, the embodiment herein is to provide a method for Network slice admission control for interworking with an EPC in a wireless network. The method includes detecting, by a SMF-PGW-C in the wireless network, that at least one UE transfer a PDN connection or a PDU session from a N1 mode to a S1 mode during an intersystem change. Further, the method includes determining, by the SMF-PGW-C, that an EPC counting is not required for a network slice of the wireless network. Further, the method includes transmitting, by the SMF-PGW-C, a message to a NSACF in the wireless network to update or reduce a number of UEs per network slice and a number of PDU sessions per network slice due to transfer of the PDN connection or the PDU session from the N1 mode to the S1 mode.

In an embodiment, if the EPS counting is not required for the network slice, the network performs network slice admission control for the S-NSSAI(s) subject to NSAC to increase the number of UEs per network slice and number of PDU sessions per network slice due to transfer of the PDN connection from S1 mode to N1 mode in case of inter-system change and decrease the number of UEs per network slice and number of PDU sessions per network slice due to transfer of the PDN connection from N1 mode to S1 mode in case of inter-system change.

In an embodiment, the proposed method provides a NSACF function for maximum number of a UEs and/or for maximum number of a protocol data unit (PDU) Sessions per network slice is performed at the time of a packet data network (PDN) connection establishment, if in case of an evolved packet core (EPC) interworking even for the UE not supporting N1 mode.

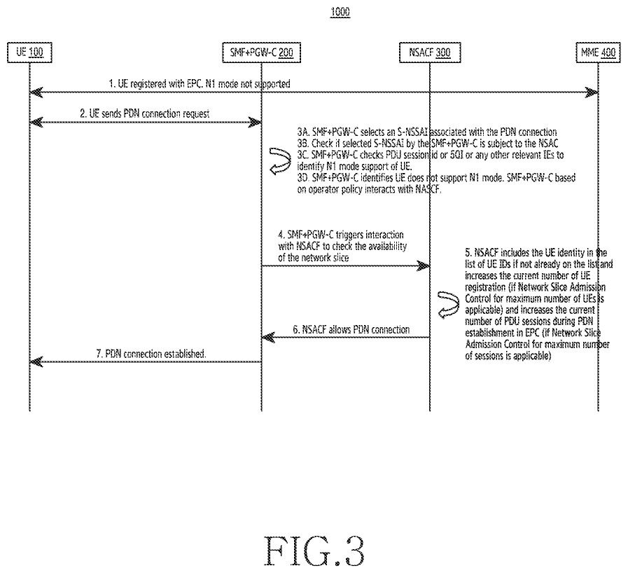

Referring now to the drawings and more particularly to FIGS. 3 through 9, where similar reference characters denote corresponding features consistently throughout the figures, there are shown preferred embodiments.

Unlike to the methods and systems of the related art, the proposed NSAC for maximum number of the UEs and/or for maximum number of PDU Sessions per network slice is performed at the time of PDN connection establishment in case of EPC interworking even for the UE not supporting N1 mode. The NSAC Function may maintain same or different threshold value for maximum number of UEs and/or for maximum number of PDU Sessions per network slice both for EPC and 5GC.

FIG. 3 illustrating a scenario of NSACF (300) check should be done in EPS, according to an embodiment of the disclosure.

Referring to FIG. 3, the steps are as follows: at operation 1, initially, the UE (100) is registered with the EPC and N1 mode not supported. At operation 2, the UE (100) sends a PDN connection request to the SMF+PGW-C (200).

At operation 3A, the SMF+PGW-C (200) selects an S-NSSAI associated with the PDN connection. At operation 3B, the SMF+PGW-C (200) checks if selected S-NSSAI by the SMF+PGW-C (200) is subject to the NSAC. At operation 3C, the SMF+PGW-C (200) checks for example the PDU session ID or 5QI or any other relevant IEs to identify N1 mode support of UE (100). At operation 3D, the SMF+PGW-C (200) identifies that the UE (100) does not support N1 mode. The SMF+PGW-C identify interaction needed with NSACF (300) based on operator policy.

At operation 4, the SMF+PGW-C (200) triggers interaction with NSACF (300) to check the availability of the network slice for this PDN connection and request to increase the count. At operation 5, the NSACF (300) includes the UE identity in the list of UE IDs if not already on the list and increases the current number of UE registration (if Network Slice Admission Control for maximum number of UEs is applicable) and increases the current number of PDU sessions (if Network Slice Admission Control for maximum number of sessions is applicable) or PDN connections when PDN connection is established.

At operation 6, the NSACF (300) allows PDN connection because threshold limit is not reached. At operation 7, at the end, the PDN connection is established. Assuming there was quota available for this. At operation 8, if there was no quota for PDN connections then PDN connection establishment will fail.

Unlike to the methods and systems of the related art, the proposed NSAC for maximum number of UEs and/or for maximum number of the PDU Sessions per network slice may not be performed at the time of the PDN connection establishment for the UE (100) not supporting N1 mode and only if N1 mode is supported SMF+PGW-C (200) the SMF+PGW-C (200) triggers interaction with NSACF (300) to check the availability of the network slice for this PDN connection/PDU session and request to increase the count of number of UEs and number of PDU sessions.

The SMF+PGW-C (200) may identify the UE (100) not having N1 mode support i.e. UE (100) does not support 5G system/UE (100) does not have 5GS capability/UE (100) supports EPS only and will not perform inter system change to 5GS either from the PDU session id IE (for e.g. in Protocol Configuration Options (PCO) or Extended Protocol Configuration Options (ePCO)) or 5QI IE value or any other N1 mode relevant IEs or a new IE which will indicate if the UE (100) supports N1 mode included during connection establishment request or any of the NAS signaling message from the UE (100).

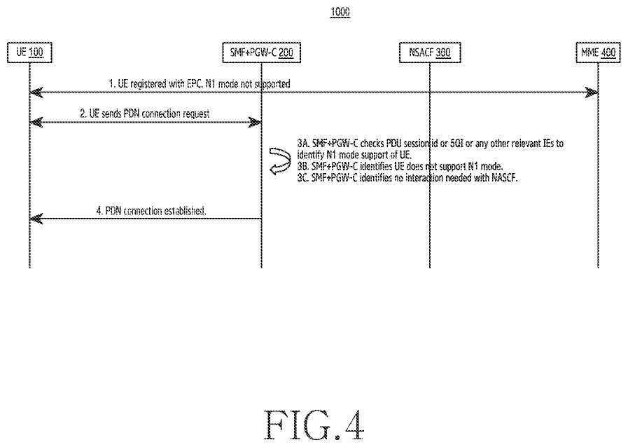

FIG. 4 illustrating a scenario of NSACF (300) check should not be done in EPS for n1 mode disabled UE, according to an embodiment of the disclosure.

Referring to FIG. 4, at operation 1, initially, the UE (100) is registered with EPC. N1 mode not supported. At operation 2, Then the UE (100) sends PDN connection request.

At operation 3A, the SMF+PGW-C (200) checks PDU session id or 5QI or any other relevant IEs to identify N1 mode support of UE (100). At operation 3B, the SMF+PGW-C (200) identifies UE (100) does not support N1 mode. At operation 3C, the SMF+PGW-C (200) identifies no interaction needed with NSACF. At operation 4, at the end, the PDN Connection is established, i.e., PDN connection establishment is successful even if the threshold of PDU session IDs is reached at the network. If N1 mode is supported by the UE SMF+PGW-C (200) the SMF+PGW-C (200) triggers interaction with NSACF (300) to check the availability of the network slice for this PDN connection/PDU session and request to increase the count of number of UEs and number of PDU sessions.

Unlike to the methods and systems of the related art, the proposed method provides a method and system to inter system change from 5GC to EPC.

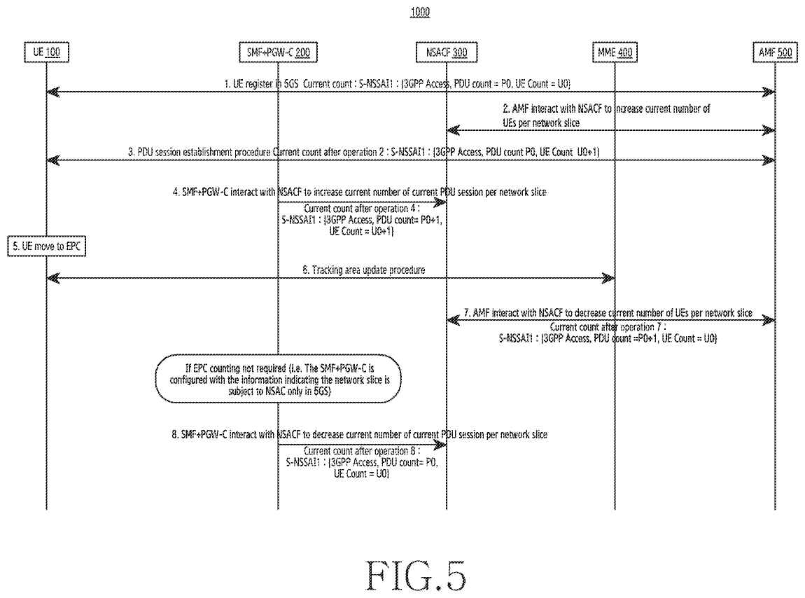

FIG. 5 illustrating a scenario of inter system change from the 5GC to the EPC, according to an embodiment of the disclosure.

Referring to FIG. 5 consider a proposed method, below are the steps:

When UE (100) move (inter system change) from 5GC (also can be called as 5GS) to EPC (also can be called as EPS), if SMF+PGW-C identified that,

PDU session with S-NSSAI1 was established on 5GC on 3GPP access

(SMF+PGW-C (200) shall maintain the radio access/access type on which PDU/PDN session is established)

The S-NSSAI1 is subject to NSAC.

The SMF+PGW-C (200) is configured with EPC counting not required (i.e. network slice is subject to NSAC only in 5GS).

The SMF+PGW-C (200) interact with NSACF (300) to decrease current number of current PDU session per network slice (shown in step-8).

If the UE (100) perform intersystem change from EPC/ePDG (S1 mode) to (5GS) N1 mode or performs handover of the PDN connection/PDU session from EPC/ePDG (S1 mode) to (5GS) N1 mode then detecting, by a Session Management Function-Packet Data Network Gateway (SMF-PGW-C) (200) or the AMF in the wireless network (1000), that at least one UE (100) transfer a PDN connection or a PDU session from a S1 mode to a N1 mode during an intersystem change or due to PDN connection with Handover flag.

For Maximum number of registered UEs:

1) SMF shall decrease count for maximum number of registered UE for S-NSSSAI-X.

2) AMF increase count for maximum number of registered UE for S-NSSSAI-X.

For the PDU session admission control either:

3A) SMF doesn't do admission control for the PDU session (i.e. it will not interact with NSACF for either increase or decrease of the count) if it is already have done the admission control in the past, so that count for maximum number of PDU session for S-NSSSAI-X remains the same, or

3B) SMF shall decrease count for maximum number of PDU session for S-NSSSAI-X and increase count for count for maximum number of PDU session for S-NSSSAI-X.

In EPS network, in case of Detach or PDN disconnection request is received from the UE and if EPC counting is not required, SMF shall check if admission control is performed or not in past. If admission control is performed in 5GC, SMF/AMF shall interact with NSACF and decrease count for maximum number of PDU session for S-NSSSAI-X and maximum number of UEs. Alternatively, in case of Detach or PDN disconnection request is received from the UE and optionally if EPC counting is not required, SMF/AMF interact with NSACF and shall decrease count for maximum number of PDU session for S-NSSSAI-X and maximum number of UEs.

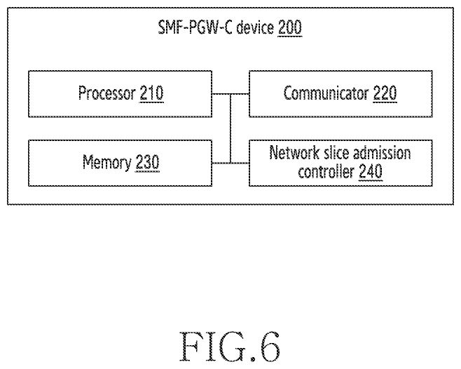

FIG. 6 shows various hardware components of the SMF-PGW-C (aka “SMF+PGW-C”) (200), according to an embodiment of the disclosure. In an embodiment, the SMF-PGW-C (200) includes a processor (210), a communicator (220), a memory (230) and a network slice admission controller (240). The processor (210) is coupled with the communicator (220), the memory (230), and the network slice admission controller (240). In addition, the operation of the network slice admission controller (240) may be performed by the processor (210).

The network slice admission controller (240) detects that the at least one UE (100) transfers the PDN connection or the PDU session from the N1 mode to the S1 mode during an intersystem change. Further, the network slice admission controller (240) determines that the EPC counting is not required for the network slice of the wireless network (1000). Further, the network slice admission controller (240) transmits the message to the NSACF (300) to update or reduce the number of UEs per network slice and the number of PDU sessions per network slice due to transfer of the PDN connection or the PDU session from the N1 mode to the S1 mode.

The network slice admission controller (240) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although FIG. 6 shows various hardware components of the SMF-PGW-C (200) but it is to be understood that other embodiments are not limited thereon. In other embodiments, the SMF-PGW-C (200) may include a lesser or greater number of components. Further, the labels or names of the components are used only for illustrative purpose and does not limit the scope of the disclosure. One or more components can be combined together to perform same or substantially similar function in the SMF-PGW-C (200).

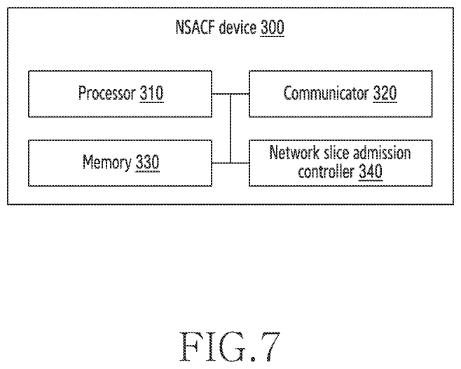

FIG. 7 shows various hardware components of the NSACF (300), according to an embodiment of the disclosure. In an embodiment, the NSACF (300) includes a processor (310), a communicator (320), a memory (330) and a network slice admission controller (340). The processor (310) is coupled with the communicator (320), the memory (330), and the network slice admission controller (340). In addition, the operation of the network slice admission controller (340) may be performed by the processor (310).

The network slice admission controller (340) detects that the EPC counting is not required for the network slice of the wireless network (1000). Further, the network slice admission controller (340) receives the message from the SMF-PGW-C (200) to update or reduce the number of UEs per network slice and a number of PDU sessions per network slice when the at least one UE (100) transfers the PDN connection or the PDU session from the N1 mode to the S1 mode during the intersystem change. Optionally, the network slice admission controller (340) detects that the at least one UE (100) transfers the PDN connection or the PDU session from the N1 mode to the S1 mode during an intersystem change. Based on the message received from the SMF-PGW-C (200), the network slice admission controller (340) updates or reduces the number of UEs per network slice and the number of PDU sessions per network slice.

The network slice admission controller (340) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (310) is configured to execute instructions stored in the memory (330) and to perform various processes. The communicator (320) is configured for communicating internally between internal hardware components and with external devices via one or more networks. The memory (330) also stores instructions to be executed by the processor (310). The memory (330) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (330) may, in some examples, be considered a non-transitory storage medium. The term “non-transitory” may indicate that the storage medium is not embodied in a carrier wave or a propagated signal. However, the term “non-transitory” should not be interpreted that the memory (330) is non-movable. In certain examples, a non-transitory storage medium may store data that can, over time, change (e.g., in Random Access Memory (RAM) or cache).

Although FIG. 7 shows various hardware components of the NSACF (300) but it is to be understood that other embodiments are not limited thereon. In other embodiments, the NSACF (300) may include a lesser or greater number of components. Further, the labels or names of the components are used only for illustrative purpose and does not limit the scope of the disclosure. One or more components can be combined together to perform same or substantially similar function in the NSACF (300).

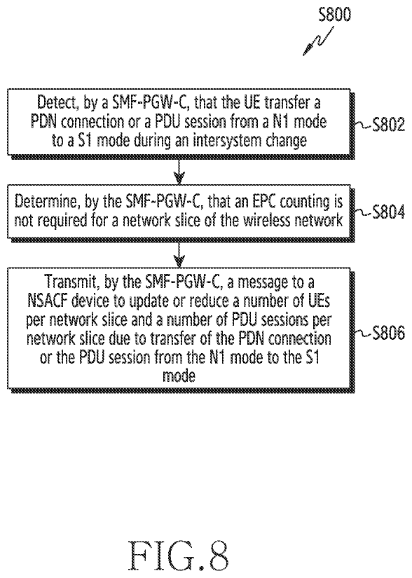

FIG. 8 is a flow chart illustrating a method, implemented by a SMF-PGW-C, for the network slice admission control for interworking with the EPC in a wireless network, according to an embodiment of the disclosure. The operations S802-S806 of flowchart S800 are performed by the network slice admission controller (240).

At operation S802, the method includes detecting that the at least one UE (100) transfer the PDN connection or the PDU session from the N1 mode to the S1 mode during the intersystem change. At operation S804, the method includes determining that the EPC counting is not required for the network slice of the wireless network (1000). At operation S806, the method includes transmitting the message to the NSACF (300) to update or reduce the number of UEs per network slice and a number of PDU sessions per network slice due to transfer of the PDN connection or the PDU session from the N1 mode to the S1 mode. The SMF-PGW-C (200) determines that UE (100) transfer the PDN connection or the PDU session from the N1 mode to the S1 mode during the intersystem change for example based on ESM message received from UE like PDN connection establishment with handover indication or based on message exchanges with EPS network like MME etc.

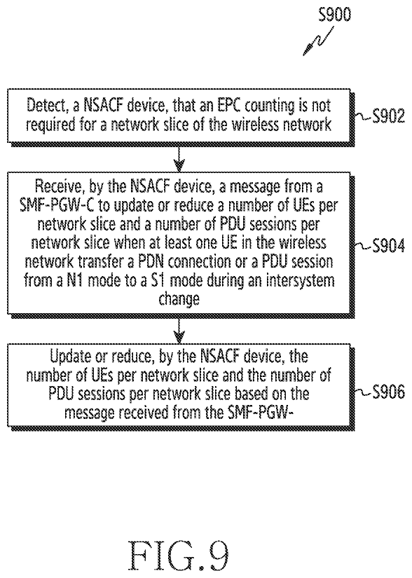

FIG. 9 is a flow chart illustrating a method, implemented by a NSACF, for Network slice admission control for interworking with the EPC in a wireless network, according to an embodiment of the disclosure. The operations S902-S906 of flowchart S900 are performed by the network slice admission controller (340).

At operation S902, the method includes detecting that the EPC counting is not required for the network slice of the wireless network (1000). At operation S904, the method includes receiving the message from the SMF-PGW-C (200) to update or reduce the number of UEs per network slice and a number of PDU sessions per network slice when the at least one UE (100) transfer the PDN connection or the PDU session from the N1 mode to the S1 mode during the intersystem change. At operation S906, the method includes updating or reducing the number of UEs per network slice and the number of PDU sessions per network slice based on the message received from the SMF-PGW-C (200).

The various actions, acts, blocks, steps, or the like in the flow charts (S800 and S900) may be performed in the order presented, in a different order or simultaneously. Further, in some embodiments, some of the actions, acts, blocks, steps, or the like may be omitted, added, modified, skipped, or the like without departing from the scope of the disclosure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

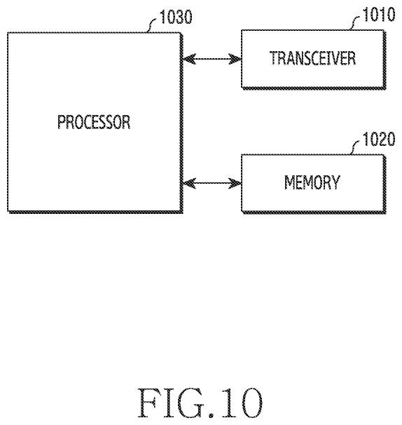

FIG. 10 is a block diagram showing an internal structure of a network entity, according to an embodiment of the disclosure.

Referring to FIG. 10, the network entity includes a transceiver 1010, a memory 1020, and a processor 1030. The transceiver 1010, the memory 1020, and the processor 1030 of the network entity may operate according to a communication method of the network entity described above. However, the components of the terminal are not limited thereto. For example, the network entity may include fewer or a greater number of components than those described above. In addition, the processor 1030, the transceiver 1010, and the memory 1020 may be implemented as a single chip. Also, the processor 1030 may include at least one processor. The network entity of FIG. 10 corresponds to the SMF-PGW-C device 200 of FIG. 6 and the NSACF device 300 of FIG. 7.

The network entity includes at least one entity of a core network. For example, the network entity includes an AMF, a session management function (SMF), a policy control function (PCF), a network repository function (NRF), a user plane function (UPF), a network slicing selection function (NSSF), an authentication server function (AUSF), a UDM and a network exposure function (NEF), but the network entity is not limited thereto.

The transceiver 1010 collectively refers to a network entity receiver and a network entity transmitter, and may transmit/receive a signal to/from a base station or a UE. The signal transmitted or received to or from the base station or the UE may include control information and data. In this regard, the transceiver 1010 may include an RF transmitter for up-converting and amplifying a frequency of a transmitted signal, and an RF receiver for amplifying low-noise and down-converting a frequency of a received signal. However, this is only an example of the transceiver 1010 and components of the transceiver 1010 are not limited to the RF transmitter and the RF receiver.

The transceiver 1010 may receive and output, to the processor 1030, a signal through a wireless channel, and transmit a signal output from the processor 1030 through the wireless channel.

The memory 1020 may store a program and data required for operations of the network entity. Also, the memory 1020 may store control information or data included in a signal obtained by the network entity. The memory 1020 may be a storage medium, such as a ROM, a RAM, a hard disk, a CD-ROM, and a DVD, or a combination of storage media.

The processor 1030 may control a series of processes such that the network entity operates as described above. For example, the transceiver 1010 may receive a data signal including a control signal, and the processor 1030 may determine a result of receiving the data signal.

FIG. 11 illustrates a structure of a UE according to an embodiment of the disclosure of the disclosure.

Referring to FIG. 11, the UE according to an embodiment may include a transceiver 1110, a memory 1120, and a processor 1130. The transceiver 1110, the memory 1120, and the processor 1130 of the UE may operate according to a communication method of the UE described above. However, the components of the UE are not limited thereto. For example, the UE may include more or fewer components than those described above. In addition, the processor 1130, the transceiver 1110, and the memory 1120 may be implemented as a single chip. Also, the processor 1130 may include at least one processor. Furthermore, the UE of FIG. 11 corresponds to the UE (100) of FIG. 1. In addition to, the UE of FIG. 11 corresponds to the UE (100) of FIG. 10.

The transceiver 1110 collectively refers to a UE receiver and a UE transmitter, and may transmit/receive a signal to/from a base station or a network entity. The signal transmitted or received to or from the base station or a network entity may include control information and data. The transceiver 1110 may include a RF transmitter for up-converting and amplifying a frequency of a transmitted signal, and a RF receiver for amplifying low-noise and down-converting a frequency of a received signal. However, this is only an example of the transceiver 1110 and components of the transceiver 1110 are not limited to the RF transmitter and the RF receiver.

Also, the transceiver 1110 may receive and output, to the processor 1130, a signal through a wireless channel, and transmit a signal output from the processor 1130 through the wireless channel.

The memory 1120 may store a program and data required for operations of the UE. Also, the memory 1120 may store control information or data included in a signal obtained by the UE. The memory 1120 may be a storage medium, such as read-only memory (ROM), random access memory (RAM), a hard disk, a CD-ROM, and a DVD, or a combination of storage media.

The processor 1130 may control a series of processes such that the UE operates as described above. For example, the transceiver 1110 may receive a data signal including a control signal transmitted by the base station or the network entity, and the processor 1130 may determine a result of receiving the control signal and the data signal transmitted by the base station or the network entity.

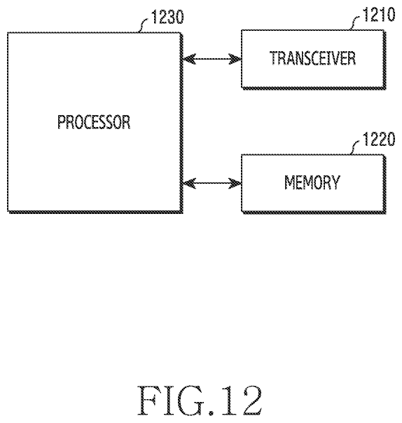

FIG. 12 illustrates a structure of a base station according to an embodiment of the disclosure.

Referring to FIG. 12, the base station according to an embodiment may include a transceiver 1210, a memory 1220, and a processor 1230. The transceiver 1210, the memory 1220, and the processor 1230 of the base station may operate according to a communication method of the base station described above. However, the components of the base station are not limited thereto. For example, the base station may include more or fewer components than those described above. In addition, the processor 1230, the transceiver 1210, and the memory 1220 may be implemented as a single chip. Also, the processor 1230 may include at least one processor. Furthermore, the base station of FIG. 12 corresponds to the BS of FIG. 10.

The transceiver 1210 collectively refers to a base station receiver and a base station transmitter, and may transmit/receive a signal to/from a terminal (UE) or a network entity. The signal transmitted or received to or from the terminal or a network entity may include control information and data. The transceiver 1210 may include a RF transmitter for up-converting and amplifying a frequency of a transmitted signal, and a RF receiver for amplifying low-noise and down-converting a frequency of a received signal. However, this is only an example of the transceiver 1210 and components of the transceiver 1210 are not limited to the RF transmitter and the RF receiver.

Also, the transceiver 1210 may receive and output, to the processor 1230, a signal through a wireless channel, and transmit a signal output from the processor 1230 through the wireless channel.

The memory 1220 may store a program and data required for operations of the base station. Also, the memory 1220 may store control information or data included in a signal obtained by the base station. The memory 1220 may be a storage medium, such as read-only memory (ROM), random access memory (RAM), a hard disk, a CD-ROM, and a DVD, or a combination of storage media.

The processor 1230 may control a series of processes such that the base station operates as described above. For example, the transceiver 1210 may receive a data signal including a control signal transmitted by the terminal, and the processor 1230 may determine a result of receiving the control signal and the data signal transmitted by the terminal.

In one embodiment, a method for a network slice admission control for interworking with an Evolved Packet Core Network (EPC) in a wireless network. The method includes detecting, by a Session Management Function-Packet Data Network Gateway (SMF-PGW-C) in the wireless network, that at least one UE transfer a PDN connection or a PDU session from a N1 mode to a S1 mode during an intersystem change, determining, by the SMF-PGW-C, that an EPC counting is not required for a network slice of the wireless network, and transmitting, by the SMF-PGW-C, a message to a Network Slice Admission Control Function (NSACF) in the wireless network to update or reduce a number of UEs per network slice and a number of PDU sessions per network slice due to transfer of the PDN connection or the PDU session from the N1 mode to the S1 mode.

In one embodiment, a method is provided. The method includes receiving, by the SMF-PGW-C, a message for allowing PDN connection from the NSACF, and transmitting, by the SMF-PGW-C, a message for establishing PDN connection to UE.

In one embodiment, a method is provided. wherein determining of that an EPC counting is not required for a network slice of the wireless network comprises. The method includes selecting, by the SMF-PGW-C, an S-NSSAI associated with the PDN connection and checking, by the SMF-PGW-C, if selected S-NSSAI by the SMF+PGW-C is subject to the NSAC.

In one embodiment, a method is provided. The method includes checking, by the SMF-PGW-C, at least one of the PDU session ID, 5QI, or any other relevant IE s (information elements) to identify N1 mode support of UE, and identifying, by the SMF-PGW-C, whether the UE supports N1 mode and interaction needed with NSACF based on operator policy.

In one embodiment, a method for Network slice admission control for interworking with an Evolved Packet Core Network (EPC) in a wireless network. The method includes detecting, by a Network Slice Admission Control Function (NSACF) in the wireless network, that an EPC counting is not required for a network slice of the wireless network, receiving, by the NSACF, a message from a Session Management Function-Packet Data Network Gateway (SMF-PGW-C) in the wireless network to update or reduce a number of UEs per network slice and a number of PDU sessions per network slice when at least one UE in the wireless network transfer a PDN connection or a PDU session from a N1 mode to a S1 mode during an intersystem change, and updating, by the NSACF, the number of UEs per network slice and the number of PDU sessions per network slice based on the message received from the SMF-PGW-C.

In one embodiment, a method is provided. The method includes detecting, by the NSACF, that the at least one UE transfers the PDN connection or the PDU session from the N1 mode to the S1 mode during an intersystem change.

In one embodiment, a method is provided. The method includes reducing, by the NSACF, the number of UEs per network slice and the number of PDU sessions per network slice based on the message received from the SMF-PGW-C.

In one embodiment, a Session Management Function-Packet Data Network Gateway (SMF-PGW-C) for Network slice admission control for interworking with an Evolved Packet Core Network (EPC) in a wireless network. The SMF-PGW-C comprises a transceiver, a processor, and coupled with transceiver. The processor is configured to a transceiver; and a processor, coupled with the transceiver and the processor, configured to detect that at least one UE transfers a PDN connection or a PDU session from a N1 mode to a S1 mode during an intersystem change, determine that an EPC counting is not required for a network slice of the wireless network, and transmit a message to a Network Slice Admission Control Function (NSACF) in the wireless network to update or reduce a number of UEs per network slice and a number of PDU sessions per network slice due to transfer of the PDN connection or the PDU session from the N1 mode to the S1 mode.

In one embodiment, wherein the processor is further configured to receive a message for allowing PDN connection from the NSACF, and transmit a message for establishing PDN connection to UE.

In one embodiment, wherein the processor is further configured to select an S-NSSAI associated with the PDN connection, and check if selected S-NSSAI by the SMF+PGW-C is subject to the NSAC.

In one embodiment, wherein the processor is further configured to check at least one of the PDU session ID, 5QI, or any other relevant IE s (information elements) to identify N1 mode support of UE, and identify whether the UE supports N1 mode and interaction needed with NSACF based on operator policy.

In one embodiment, a Network Slice Admission Control Function (NSACF) for Network slice admission control for interworking with an Evolved Packet Core Network (EPC) in a wireless network. The NSACF is configured to a transceiver; and a processor, coupled with the transceiver and the processor. The processor is configured to detect that an EPC counting is not required for a network slice of the wireless network, receive a message from a Session Management Function-Packet Data Network Gateway (SMF-PGW-C) in the wireless network to update or reduce a number of UEs per network slice and a number of PDU sessions per network slice when at least one UE in the wireless network transfers a PDN connection or a PDU session from a N1 mode to a S1 mode during an intersystem change, and update the number of UEs per network slice and the number of PDU sessions per network slice based on the message received from the SMF-PGW-C.

In one embodiment, wherein the processor is further configured to detect that the at least one UE transfers the PDN connection or the PDU session from the N1 mode to the S1 mode during an intersystem change.

In one embodiment, wherein the processor is further configured to reduce the number of UEs per network slice and the number of PDU sessions per network slice based on the message received from the SMF-PGW-C.

The above flowcharts illustrate example methods that can be implemented in accordance with the principles of the disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

The methods according to the embodiments described in the claims or the detailed description of the disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the disclosure.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network such as the Internet, an intranet, a local area network (LAN), a wireless LAN (WLAN), or a storage area network (SAN), or a combination thereof. The storage device may be connected through an external port to an apparatus according the embodiments of the disclosure. Another storage device on the communication network may also be connected to the apparatus performing the embodiments of the disclosure.

In the afore-described embodiments of the disclosure, elements included in the disclosure are expressed in a singular or plural form according to the embodiments. However, the singular or plural form is appropriately selected for convenience of explanation and the disclosure is not limited thereto. As such, an element expressed in a plural form may also be configured as a single element, and an element expressed in a singular form may also be configured as plural elements.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for Network slice admission control for interworking with an Evolved Packet Core Network (EPC) in a wireless network, the method comprises:
detecting, by a Session Management Function-Packet Data Network Gateway (SMF-PGW-C) in the wireless network, that at least one User Equipment (UE) transfer a Packet Data Network (PDN) connection or a Protocol Data Unit (PDU) session from a N1 mode to a S1 mode during an intersystem change;
determining, by the SMF-PGW-C, that an EPC counting is not required for a network slice of the wireless network; and
transmitting, by the SMF-PGW-C, a message to a Network Slice Admission Control Function (NSACF) in the wireless network to update or reduce a number of UEs per network slice and a number of PDU sessions per network slice due to transfer of the PDN connection or the PDU session from the N1 mode to the S1 mode.

2. The method of claim 1, further comprising:
receiving, by the SMF-PGW-C, a message for allowing PDN connection from the NSACF; and
transmitting, by the SMF-PGW-C, a message for establishing PDN connection to UE.

3. The method of claim 1, wherein determining of that an EPC counting is not required for a network slice of the wireless network comprises:
selecting, by the SMF-PGW-C, a Single Network Slice Selection Assistance Information (S-NSSAI) associated with the PDN connection; and
checking, by the SMF-PGW-C, if selected S-NSSAI by the SMF-PGW-C is subject to the NSACF.

4. The method of claim 3, further comprising:
checking, by the SMF-PGW-C, at least one of a PDU session ID, 5QI, or any other relevant information elements (IEs) to identify N1 mode support of UE; and
identifying, by the SMF-PGW-C, whether the UE supports N1 mode and interaction needed with NSACF based on operator policy.

5. A method for Network slice admission control for interworking with an Evolved Packet Core Network (EPC) in a wireless network, the method comprises:
detecting, by a Network Slice Admission Control Function (NSACF) in the wireless network, that an EPC counting is not required for a network slice of the wireless network;
receiving, by the NSACF, a message from a Session Management Function-Packet Data Network Gateway (SMF-PGW-C) in the wireless network to update or reduce a number of User Equipments (UEs) per network slice and a number of Protocol Data Unit (PDU) sessions per network slice when at least one UE in a wireless network transfer a Packet Data Network (PDN) connection or a PDU session from a N1 mode to a S1 mode during an intersystem change; and
updating, by the NSACF, the number of UEs per network slice and the number of PDU sessions per network slice based on the message received from the SMF-PGW-C.

6. The method of claim 5, further comprising:
detecting, by the NSACF, that the at least one UE transfers the PDN connection or the PDU session from the N1 mode to the S1 mode during an intersystem change.

7. The method of claim 5, further comprising:
reducing, by the NSACF, the number of UEs per network slice and the number of PDU sessions per network slice based on the message received from the SMF-PGW-C.

8. A Session Management Function-Packet Data Network Gateway (SMF-PGW-C) for Network slice admission control for interworking with an Evolved Packet Core Network (EPC) in a wireless network, the SMF-PGW-C comprises:
a transceiver; and
a processor, coupled with the transceiver and the processor, configured to:
detect that at least one User Equipment (UE) transfers a Packet Data Network (PDN) connection or a Protocol Data Unit (PDU) session from a N1 mode to a S1 mode during an intersystem change,
determine that an EPC counting is not required for a network slice of the wireless network, and
transmit a message to a Network Slice Admission Control Function (NSACF) in the wireless network to update or reduce a number of UEs per network slice and a number of PDU sessions per network slice due to transfer of the PDN connection or the PDU session from the N1 mode to the S1 mode.

9. The SMF-PGW-C of claim 8, wherein the processor is further configured to:
receive a message for allowing PDN connection from the NSACF; and
transmit a message for establishing PDN connection to UE.

10. The SMF-PGW-C of claim 8, wherein the processor is further configured to:
select an S-NSSAI associated with the PDN connection; and
check if selected S-NSSAI by the SMF-PGW-C is subject to the NSACF.

11. The SMF-PGW-C of claim 8, wherein the processor is further configured to:
check at least one of a PDU session ID, 5QI, or any other relevant IE s (information elements) to identify N1 mode support of UE; and
identify whether the UE supports N1 mode and interaction needed with NSACF based on operator policy.

12. A Network Slice Admission Control Function (NSACF) for Network slice admission control for interworking with an Evolved Packet Core Network (EPC) in a wireless network, the NSACF comprises:
a transceiver;
a processor; and
coupled with the transceiver and configured to:
detect that an EPC counting is not required for a network slice of the wireless network,
receive a message from a Session Management Function-Packet Data Network Gateway (SMF-PGW-C) in the wireless network to update or reduce a number of User Equipments (UEs) per network slice and a number of Protocol Data Unit (PDU) sessions per network slice when at least one UE in the wireless network transfers a Packet Data Network (PDN) connection or a PDU session from a N1 mode to a S1 mode during an intersystem change, and
update the number of UEs per network slice and the number of PDU sessions per network slice based on the message received from the SMF-PGW-C.

13. The NSACF of claim 12, wherein the processor is further configured to:
detect that the at least one UE transfers the PDN connection or the PDU session from the N1 mode to the S1 mode during an intersystem change.

14. The NSACF of claim 12, wherein the processor is further configured to:
reduce the number of UEs per network slice and the number of PDU sessions per network slice based on the message received from the SMF-PGW-C.
